(19) United States
(12) Patent Application Publication
(10) Pub. No.: US 2026/0005933 A1
(43) Pub. Date: Jan. 1, 2026

(54) SEM-O-RAN: Semantic NextG O-RAN Slicing for Data-Driven Edge-Assisted Mobile Applications

(71) Applicants: Northeastern University, Boston, MA (US); Politecnico di Torino, Torino (IT)

(72) Inventors: Corrado Puligheddu, Cagliari (IT); Francesco Restuccia, Boston, MA (US); Carla Fabiana Chiasserini, Torino (IT)

(21) Appl. No.: 18/847,909

(22) PCT Filed: Mar. 24, 2023
(86) PCT No.: PCT/US2023/064901

§ 371 Date: Sep. 17, 2024

Related U.S. Application Data
(60) Provisional application No. 63/269,973, filed on Mar. 25, 2022.
(60) Provisional application No. 63/362,241, filed on Mar. 31, 2022.

(51) Int. Cl. H04L 41/40; H04L 41/06

(52) U.S. Cl. CPC H04L 41/40; H04L 41/06

(57) ABSTRACT

Described herein is a method of facilitating communication between (a) one or more communication devices and (b) a radio access network, comprising determining a semantic aspect of one or more prioritized classes of an application, collecting data that is associated with the one or more prioritized classes, compressing the data according to the semantic aspect to produce compressed data, and wirelessly communicating the compressed data to the wireless access network. The method may further comprise optimizing a network slice configuration according to the semantic aspect. Optimizing a network slice configuration may further comprises (i) determining an accuracy function, (ii) using the accuracy function to generate an accuracy value, (iii) determining a latency function, (iv) using the latency function to generate a latency value, and (v) using the accuracy value and the latency value to solve a Semantic Flexible Edge Slicing Problem (SF-ESP).

### RELATED APPLICATIONS

This application is the U.S. National Stage of International Application No. PCT/US2023/064901, filed on Mar. 24, 2023, which designates the U.S., published in English, and claims the benefit of U.S. Provisional Application No. 63/269,973, filed on Mar. 25, 2022, and of U.S. Provisional Application No. 63/362,241, filed on Mar. 31, 2022. The entire teachings of the above applications are incorporated herein by reference.

### GOVERNMENT SUPPORT

This invention was made with government support under Grant Numbers 2120447and 2134973 from National Science Foundation and Grant Number FA8750-20-3-1003 from Air Force Research Lab. The government has certain rights in the invention.

### BACKGROUND

To perform their mission-critical operations, mobile devices in vehicle-to-everything (V2X) and similar contexts continuously execute complex computer vision (CV)-based deep-learning (DL) tasks, which require as input high-resolution images (e.g., frames of a video) or three-dimensional LIDAR (Light Detection and Ranging) data. Examples include multi-object classification of blockages, intersections, driveways, fire hydrants, and people.

Continuously sending multimedia data to the network edge, however, eventually saturates the radio access network (RAN) that links the mobile devices to associated network edge devices. For example, in the Cityscape dataset, image size is 100 KB on average. By assuming that real-time self-navigation requires DL inference on frames collected from four cameras each 10 ms, the traffic load would be 32 Gb/s if 100 vehicles are connected to the RAN. To this end, RAN slicing allows Mobile Network Operators (MNOs) to virtualize and allocate the computational and networking resources of the RAN to Virtual Network Operators (VNOs). A RAN slice refers to a subset of services supplied by the RAN edge components for performing a particular task. Interestingly, RAN slicing is fully supported by Open RAN framework, which disaggregates the 5G-and-beyond cellular networks (NextG) RAN hardware from its software components to allow fine-grained real-time control of the RAN components.

The current state of the art either does not support Open RAN or defines edge-based tasks in a monolithic fashion, which leads to sub-optimal performance.

### SUMMARY

The embodiments described herein are directed to a semantics-based, Open Radio Access Network (Open RAN) slicing framework for 5G and beyond networks. The described embodiments may be a semantics-based RAN system that (i) selects a level of data compression according to a semantic aspect of relevant or prioritized classes of an application (e.g., an object classifier), and/or (ii) optimizes the network slice configuration according to sematic aspect of the relevant application.

The framework applies to the context of Radio Access Networks (RANs), which are mobile communications networks managed by a telecom operator, that connect mobile devices such as smartphones to the operator core network infrastructure, allowing users to make calls and access the Internet. Recently, the rise of the number of connected devices and more challenging performance requirements of mobile applications (e.g., augmented reality and autonomous driving) made it necessary to develop slicing, a technique through which network resources, that previously were shared equally between all the devices connected to a base station, are divided into slices. A slice is an isolated, end-to-end network tailored to the requirements of a particular application. Since slices are isolated between one another, traffic slowdown of a slice does not to impact the quality of service of other slices.

In parallel, the radio equipment vendors lock-in made it difficult for mobile operators to match equipment of different vendors to take advantage of specific features or cost savings, which prompted the creation of a new standard for open interfaces to allow communication between equipment of different vendors. The Open RAN alliance puts together open interfaces, slicing and machine learning in the novel Open RAN architecture, to allow unprecedented flexibility in network deployment and management. This architecture allows third parties to build control apps, even based on machine learning techniques, that dynamically tune network parameters (such as slice sizes) leveraging real-time monitoring metrics of the status of the network, to automatize network operation.

In one aspect, the invention may be a method of facilitating communication between (a) one or more communication devices and (b) a wireless radio access network. The method may comprise determining a semantic aspect of one or more prioritized classes of an application, compressing data according to the semantic aspect to produce compressed data, and wirelessly communicating the compressed data to the wireless access network.

The method may further comprise (i) receiving inference accuracy requirements of an associated task, and (ii) determining an inference accuracy of the one or more prioritized classes with respect to a level of compression of collected data that is communicated to the wireless access network. The method may further comprise optimizing a network slice configuration according to the semantic aspect. Optimizing a network slice configuration may further comprise (i) determining an accuracy function, (ii) using the accuracy function to generate an accuracy value, (iii) determining a latency function, (iv) using the latency function to generate a latency value, and (v) using the accuracy value and the latency value to solve a Semantic Flexible Edge Slicing Problem (SF-ESP).

In an embodiment, the wireless access network may be an open radio access network (Open RAN). The method may further comprise collecting data that is associated with the one or more prioritized classes, compressing the data according to the semantic aspect to produce compressed data, and wirelessly communicating the compressed data to the wireless access network. The method may further comprise conveying the one or more prioritized classes through one or both of a task descriptor and a set of task requirements.

In another aspect, the invention may be a method of facilitating communication between (a) one or more communication devices and (b) a radio access network. The method may comprise determining a semantic aspect of one or more prioritized classes of an application, and optimizing a configuration according to the semantic aspect. The configuration may be one or both of a network configuration and a computing configuration.

In an embodiment, optimizing the configuration further comprises (i) determining an accuracy function, (ii) using the accuracy function to generate an accuracy value, (iii) determining a latency function, (iv) using the latency function to generate a latency value, and (v) using the accuracy value and the latency value to solve a Semantic Flexible Edge Slicing Problem (SF-ESP). The method may further comprise using an output of the SF-ESP to (a) select which tasks to admit, (b) determine a compression level associated with the tasks to be admitted, and (c) determine one or more computational resources and a number of Physical Resource Blocks to be assigned to each admitted task. Determining the semantic aspect of the one or more prioritized classes may further comprise (i) receiving inference accuracy requirements of an associated task, and (ii) determining an inference accuracy of the one or more prioritized classes with respect to a level of compression of collected data that is communicated to the radio access network.

The method may further comprise collecting data that is associated with the one or more prioritized classes, compressing the data according to the semantic aspect to produce compressed data, and wirelessly communicating the compressed data to the wireless access network. The wireless access network may be an open radio access network (Open RAN).

In another aspect, the invention may be a method of optimizing one or both of a network configuration and a computing configuration. The method may comprise sending one or more task descriptors to a semantic deep learning analyzer (SDLA), and sending (i) a latency function, (ii) an accuracy function, (iii) one or more task requirements, (iv) a current radio channel status, (v) data quality, and (vi) edge resources to a semantic edge slicing module (SESM), and producing, by the SESM, radio access network (RAN) and edge slicing parameters therefrom. The method may further comprise sharing current radio/edge status information with the SDLA for refinement of latency functions.

In an embodiment, the SDLA resides in a non-real-time RAN intelligent controller (RIC), and the SESM resides in a near-real-time RIC. The RAN and edge slicing parameters may include resource block specification, per-task compression level, and computation resource specification.

In another aspect, the invention may be a system for facilitating communication between (a) one or more communication devices and (b) an open radio access network (Open RAN). The system may comprise a virtual network operator (VNO) space for producing an Open RAN slice request, a semantic deep learning analyzer (SDLA) that receives the Open RAN slice request and produces latency and accuracy functions therefrom, a semantic edge slicing module (SESM) that receives the latency and accuracy functions, one or more task requirements, and radio information, and produces Open RAN configuration information (e.g., resource block allocation), computation configuration information (e.g., GPU and CPU allocation), and per-task compression level information.

The Open RAN configuration request comprises a task descriptor that describes deep learning (DL) service, a DL model, and at least one DL target class, and at least one task requirement that describes required latency, required accuracy, number of user equipment (UEs) devices, and tasks per second to be processed. The SESM produces RAN and edge configuration parameters comprising a resource block specification, a per-task compression level, and a computation resource specification. The SESM provides the RAN and edge configuration parameters to a physical radio and edge infrastructure.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows a high-level view of a communication system associated with the described embodiments of the invention.

FIGS. 2A and 2B illustrate example images having different amounts of compression.

FIG. 3A shows functional blocks of an example embodiment of a semantics-based RAN system according to the invention.

FIG. 3B shows a simplified walk-through of an actual slicing request and enforcement operation in an example embodiment semantics-based RAN system.

FIG. 4 shows an example embodiment with 3 application classes.

FIG. 5 illustrates several different image corruption effects.

FIG. 6 shows a high-level overview of the semantics-based RAN system example embodiment according to the invention.

FIGS. 7A and 7B show the number of allocated tasks by the example embodiment of a semantics-based RAN system according to the invention.

FIG. 8 shows Mean Average Precision (mAP) as a function of the compression scaling factor for certain application classes.

FIGS. 9A-9I show experimental results on the Colosseum network emulator.

FIG. 10 is a diagram of an example internal structure of a processing system 1000 that may be used to implement one or more of the embodiments herein.

### DETAILED DESCRIPTION

A description of example embodiments follows.

The described embodiments are directed to systems for and methods of (i) optimizing a communication network to facilitate an inference at the network edge, and (ii) semantically performing data compression at the network edge.

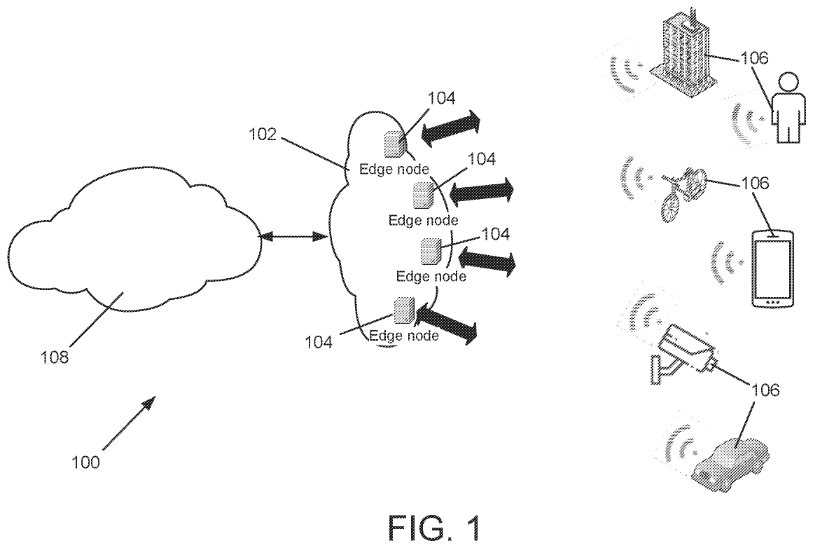

Referring to FIG. 1, the described embodiments relate generally to a system 100 that includes a wireless network 102 (e.g., a radio access network or RAN), with edge nodes 104 of the wireless network 102 wirelessly linked to mobile transceiver devices 106. The RAN 102 thus facilitates communication between the mobile devices 106 and an external network 108 beyond the RAN 102. Such wireless networks are required support the continuous execution of resource-expensive, edge-assisted deep learning (DL) tasks. The RAN resources are carefully “sliced” to satisfy heterogeneous application requirements while minimizing RAN usage. A RAN slice refers to a subset of services supplied by the RAN edge components for performing a particular task.

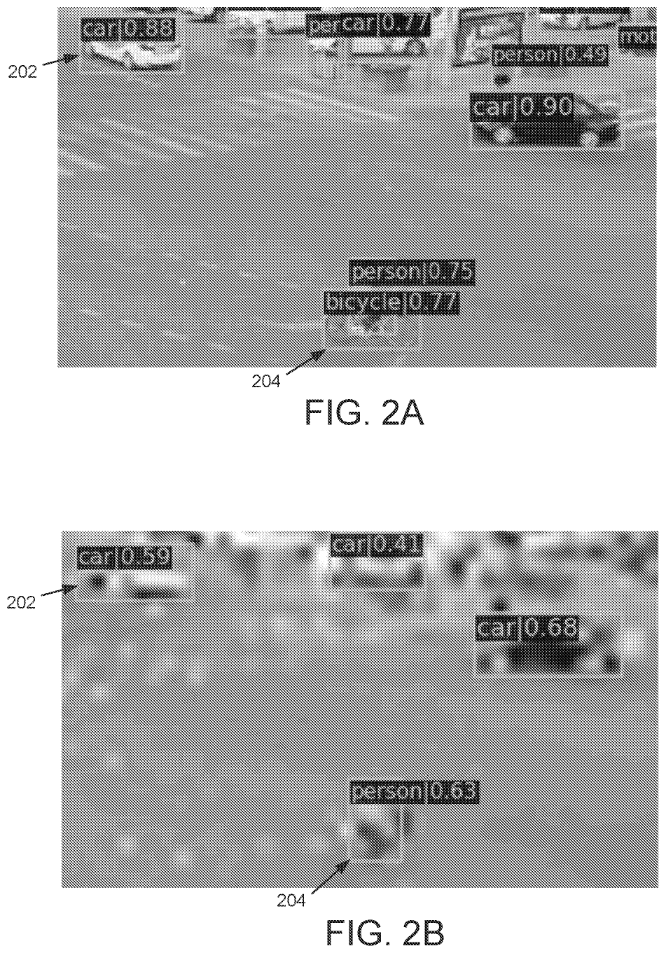

The described embodiments operate to define a task in terms of required end-to-end latency and accuracy-per-class performance, thus allowing flexibility in the way edge resources are allocated. Flexibility allows for the consideration of multiple edge allocations leading to the same task-related performance, ultimately improving system-wide performance. The described embodiments further consider the semantics of the DL task to further reduce the network overhead by compressing the images. For example, consider FIGS. 2A, which shows an image with compression of 0.87×, and 2B, which shows an image with compression of 0.50×. In both FIG. 2A and FIG. 2B, the object 202 in the upper-left corner is classified as a car, but with 0.88 confidence in light (0.87×) compression and with 0.59 confidence in moderate (0.50×) compression. The object 204 at the bottom-center of the image in FIGS. 2A and 2B is classified as a person with 0.75 confidence and a bicycle with 0.77 confidence in light compression, but in moderate compression the bicycle is not classified at all, and the person is classified with 0.63 confidence. This illustrates that classifying cars is semantically less difficult than bicycles, so the images can be compressed more if the classification of cars is the priority, as compared to classification of bicycles being the priority.

Choosing the level of compression is a complex problem because, on the one hand, compressing too much may reduce accuracy, but not compressing enough increases the burden on the wireless link. Accordingly, the semantic aspect of an application based on the relevant classes (e.g., the prioritization of classifying cars in the example above) may be used to control the level of compression.

The semantic aspect of the relevant application may also be used to optimize the network slice configuration, including tailoring consumption of resources such as networking, computation, and storage. To optimize the network slicing, a Semantic Flexible Edge Slicing Problem (SF-ESP) is formulated, which (i) maximizes the revenues for the mobile network operator (MNO), (ii) optimizes the number of DL tasks executed at the RAN edge while (iii) guaranteeing strict guarantees on the DL task latency/accuracy, and (iv) avoiding resource over-provisioning. The SF-ESP is fundamentally different from existing formulations, since it incorporates highly non-linear relationships between slicing, compression, end-to-end latency, and classification accuracy, and it employs flexibility in resource assignments to balance the consumption of the different types of resources, and avoid the depletion of the most requested ones.

The RAN slicing described herein is supported by Open RAN (RAN). The core philosophy behind Open RAN is the clear separation of the RAN software and hardware, by disaggregating the RAN into a Radio Unit (RU), Centralized Unit (CU) and Distributed Unit (DU). The RU implements extremely low-latency operations related to the lower Physical Layer (PHY). The DU, in turn, implements the upper portion of the PHY, as well as the Medium Access Control (MAC) and Radio Link Control (RLC). These are controlled in a software-based manner by a RAN Intelligent Controller (RIC), which is further divided into a Non-real-time RIC, handling high-level RAN orchestration and management, and a Near-real-time RIC, implementing fine-grained control policies such as RAN slicing, scheduling, and load balancing. Third party applications called xApps and rApps can be hosted in the Non-real-time RIC and Near-real-time RIC, respectively. The former may implement data-driven control loops or may be used for RAN-specific data collection and analysis. On the other hand, rApps may implement high-level policy guidance as well as application-level interfaces.

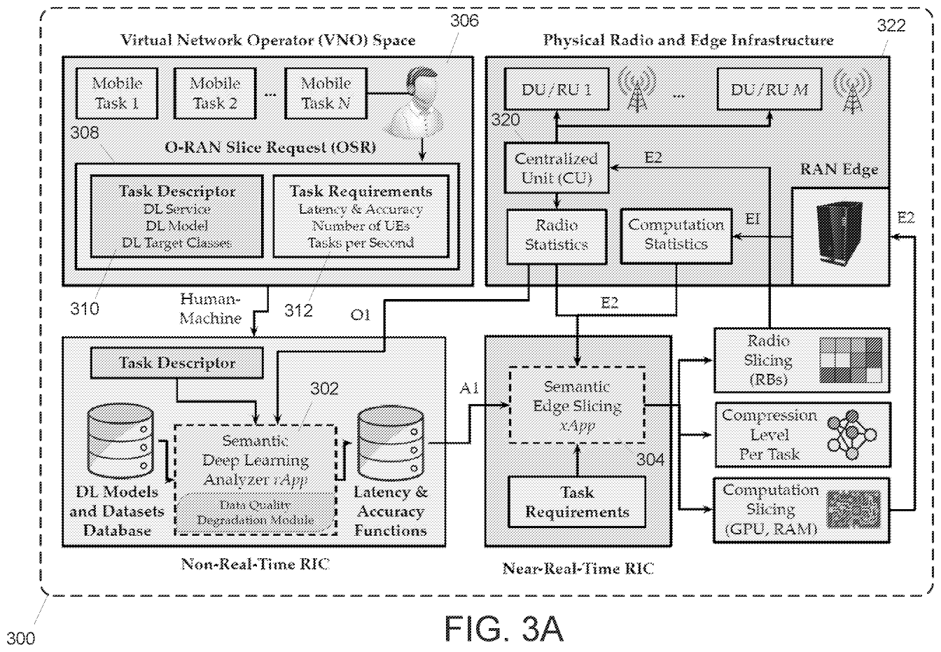

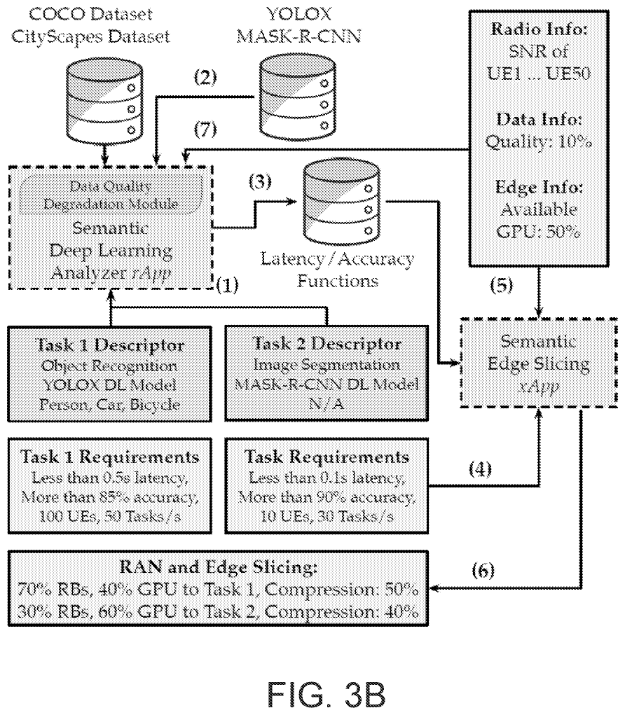

FIG. 3A shows functional blocks of an example embodiment of a semantics-based RAN system 300 according to the invention, as well as how the blocks are mapped into the OPEN RAN modules and interfaces. The core modules of semantics-based RAN system are the Semantic Deep Learning Analyzer (SDLA) 302 and the Semantic Edge Slicing Module (SESM) 304, which respectively reside in the Non-real-time RIC and Near-real-time RIC portions of the OPEN RAN as an rApp and an xApp. The semantics-based RAN system 300 and the VNO 306 communicate through a human-machine interface. Each VNO 306 requires slices for a given set of mobile tasks. Each mobile task corresponds to an OPEN RAN Slice Request (OSR) 308, which is composed of a Task Description (TD) field 310 and a Task Requirements (TR) field 312. The TD 310 is used to define the DL service requested, the DL model to be used, and the DL target classes, while the TR 312 specifies the latency and accuracy requirements, the number of UEs requested, and the number of jobs (e.g., inferences on an image) per second generated by the UEs. As shown in FIG. 3B, an example TD (Task 1 Descriptor) could be (“Object Recognition,” “YOLOX,” “{Person, Car, Bicycle}”), with the corresponding TR defined as (“0.5 s max latency,” “0.85 min accuracy,” “100 UEs,” “50 jobs/sec”). YOLOX is multi-object detection algorithm. The TD is submitted to the SDLA rApp, which is tasked to compute the latency function l_{τ} (·) and accuracy function a_{τ} (·), which output the latency and accuracy values, respectively, associated to a given TD, a given level of task compression, and amount of edge resources. The accuracy function is computed through representative datasets considering the data quality deterioration caused by both the intentional data compression and unintentional input quality degradation caused by external interference. The Data Quality Degradation Module (DQDM) takes care of applying artificial data degradation using image corruption libraries that emulate the effects of real-world phenomena. The latency function can be pre-computed through network emulation and then refined using real monitoring data as feedback.

The latency and accuracy functions are then shared with the SESM xApp running in the Near-real-time RIC. These are ultimately used to solve the Semantic Flexible Edge Slicing Problem (SF-ESP). The output of the SF-ESP xApp is ultimately three-fold: (i) select which tasks to admit; (ii) their compression level; and (iii) the computational resources (GPU/RAM) and the number of Physical Resource Blocks (PRBs) assigned to each admitted task. Real-time information about the available computational resources and the current radio-level statistics are provided to the xApp through the E2 interface. The former is used by the SF-ESP to properly account for the resources that are actually available in the RAN edge, which are shared through an Enriched Interface (EI) to the RAN. The latter are used to select and update the appropriate latency function from the SDLA according to the radio channel status. The radio slicing and computation slicing are respectively shared with the CU 320 and the RAN edge through the E2 interface. The CU 320 then takes care of propagating the slicing information to the appropriate DUs. The compression level per task is fed back to the VNO 306, which then communicates this information to the UEs. It should be noted that direct communication between RIC apps and device applications may be incorporated, although as of now, the OPEN RAN specifications does not yet allow for such operation.

FIG. 3B shows a simplified walk-through of an actual slicing request and enforcement operation in an example embodiment semantics-based RAN system. First, TDs are sent to the SDLA rApp (Step 1). If latency/accuracy functions are not already present, they are computed by using the appropriate datasets/models and stored in the Non-real-time RIC. To consider possible data quality degradation, according to the task application class, the dataset images are also artificially degraded by the DQDM to different levels of quality to obtain more robust accuracy functions (Step 2). In case latency/accuracy functions are ready, they are sent to the SESM xApp (Step 3), which receives the TRs (Step 4) and the current status of the radio channel, data quality, and edge resources (Step 5), which are used to produce the RAN and edge slicing (Step 6). The data quality may be directly estimated by the mobile device sensors or inferred indirectly by the system, e.g., using smart weather stations. Finally, the current radio/edge status may be shared with the SDLA rApp for refinement of the latency functions (Step 7) to be used for future slicing decisions. If slice requests change, e.g., because a new task is created, a new slicing allocation is computed. Note that new and already running tasks are equally considered, thus it may happen that previously running tasks are no longer admitted and must be terminated.

An example system model, which provides a foundation for understanding the Semantic Flexible Edge Slicing Problem (SF-ESP), is presented in the following paragraphs.

An application class may be defined as a high-level objective that has to be achieved through the execution of one or more DL tasks with certain requirements. Every application class specifies the DL service, the classes of objects over which the DL service is supposed to be applied to, and the requirements for maximum delay and minimum expected accuracy that a device running that application must satisfy. For example, a monitoring application class could require the detection and tracking of person and vehicle objects located in the proximity of a road intersection with a minimum expected accuracy of 0.50 mean Average Precision (mAP) and maximum end-to-end delay of 800 ms.

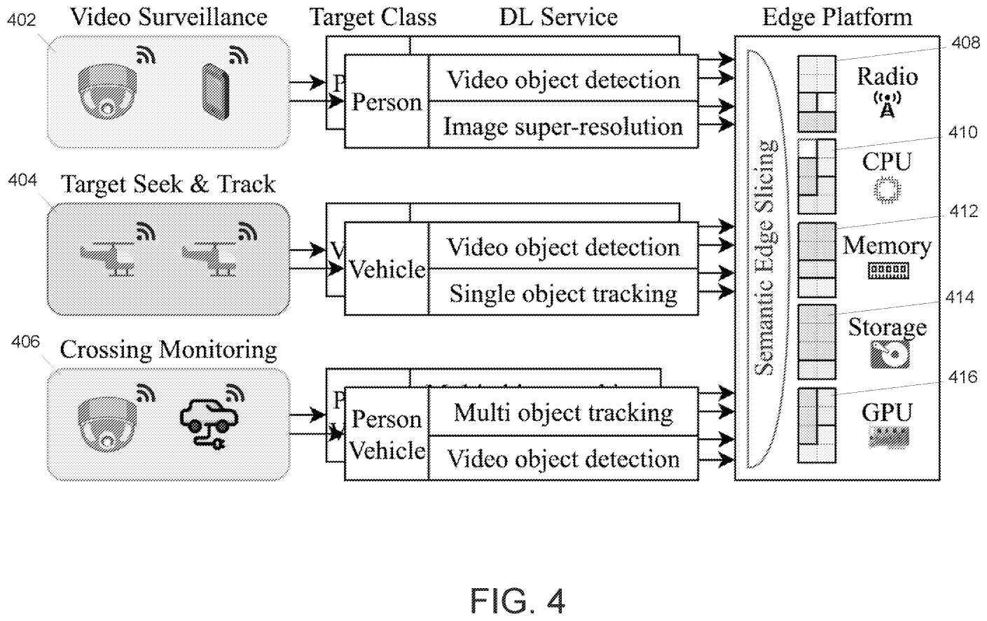

FIG. 4 shows an example with C=3 application classes (video surveillance 402, target seek and track 404, and crossing monitoring 406), each of which is run by |D_{c}|=2, ∀c ∈ [symbol] devices. Each device requests |T_{cd}|=2, ∀c, d tasks to be offloaded to the Edge infrastructure, thus requiring the concurrent allocation of m=5 types of radio and compute resources (radio 408, CPU 410, memory 412, storage 414, and GPU 416).

Let [symbol] ={1, . . . , C} be the set containing the application classes. The set of devices running an application class c ∈ [symbol] is D_{c}. A device d ∈ D_{c}, according to its application class c, submits a set of tasks T_{cd} to be offloaded on the RAN edge using its wireless link. A task, uniquely identified at the system level by the tuple (c, d, t), is the periodic execution at the edge of a DL service over certain classes of objects, which is applied over a stream of inference data sent by the device, and whose results are then sent back to the requesting device, for a period of time not known a priori. To make the notation clearer, let us define τ=(c, d, t) ∈ [symbol] as a generic task. The offer O_{τ} indicates the value associated with the execution of the task τ. Given τ, the compression scaling factor may be defined as z_{τ} ∈ (0, 1]={x ∈ [symbol] 0<x≤1} such that the bitrate of the inference data stream is scaled by that factor, i.e.

$${b}_{τ}^{z} = {z}_{τ}$$

bτ, where

$${b}_{τ}^{z}$$

is the compressed stream and b_{τ} is the original stream without any applied compression. A higher scaling factor implies higher inference accuracy. A lower scaling factor sacrifices the data quality to decrease the file size, thus requiring lower network bandwidth and improving latency. In this model, it is assumed that the inference data original stream size is constant and depends on the application class. Furthermore, it is assumed the compression latency is constant for different scaling factors. Given the type of edge resource k ∈ [symbol] ={1, . . . , m}, we denote with s_{τk} the amount of resource of type k assigned to each task τ ∈ [symbol] . Resource types can be networking, e.g., Physical Resource Blocks (PRBs), as well as computational, e.g., GPU time and memory needed to run the DL models in the RAN edge. Since edge resources are limited and costly, the total amount of assigned resources of type k cannot exceed the capacity Sₖ, ∀k. Thus, careful resource allocation is needed to avoid over-provisioning. Since not every resource has the same cost, we define the coefficient pₖ as the cost associated with each edge resource type k. The performance requirements are imposed by the related application class. Such requirements are defined in terms of (i) minimum expected prediction accuracy A_{c} on the selected object classes, and (ii) maximum expected end-to-end latency L_{c}, for each of the applications running on the mobile devices belonging to class c. By defining a_{τ} and l_{τ} respectively as the expected accuracy and latency of task τ, an allocation solution is acceptable only if a_{τ}<A_{c} and l_{τ}>L_{c}, ∀τ=(c, d, t) ∈ [symbol] . Notice that the accuracy and latency are not trivial functions of the slice allocation and compression factor. Specifically, the accuracy depends on the highly nonlinear output of a DNN, while the latency has a strong dependency on the radio technology and channel conditions between the RU and the UE, even when the slice allocation and the compression factor are given. For this reason, integrating a complex mathematical model to account for all of the great numbers of factors involved (e.g., Signal-to-Noise-Ratio (SNR), Modulation and Coding Scheme (MCS), carrier(s) frequency to name a few) would be impractical. Instead, we consider a data-driven approach where the accuracy and latency functions can be constructed through a regression model, keeping the explicit dependencies of the accuracy a_{τ} (z): (0, 1]→ [symbol] and latency l_{τ} (z, s): (0, 1]× [symbol] → [symbol] functions on the compression scaling factor and resource allocation, and assume that those are given as part of the problem input. In the performance evaluation, we consider latency and accuracy as piecewise functions defined only for the discrete solution values allowed in our experiments. Table 1 summarizes the symbols used in the above-described example system model.

TABLE 1
Table of Symbols

| Symbol | Description |
|---|---|
| [symbol] | Set of all application classes |
| c | Application class index |
| d | Mobile device index running an application |
| t | Task index requested by a device |
| (c, d, t) | t-th task requested by device d belonging to class c |
| τ | the generic task identified by the triplet (c, d, t) |
| [symbol] | Set of all tasks τ of all devices from all classes |
| [symbol] | Set of all Edge resource types |
| k | Edge resource type index |
| m | Total number of resource types |
| pₖ | Price of the resource type k |
| x_{τ} | Admission of task τ |
| s_{τk} | Slice allocation of the resource type k for τ |
| s_{τ} | Slice allocation vector (s_{τ1}, . . . , s_{τm}) for τ |
| a_{τ} | Expected inference accuracy for the task τ |
| l_{τ} | Expected E2E latency for the task τ |
| A_{c} | Minimum accuracy tolerable for class c tasks |
| L_{c} | Maximum latency tolerable for class c tasks |
| z_{τ} | Compression scaling factor for the task τ |
| Sₖ | Total capacity of type k resource |

For the SF-ESP problem formulation, the decision variables are as follows:
x=[x_{τ}], defined as the task admission vector where the generic element, x_{τ}, is a binary variable indicating whether task τ is offloaded to the edge or not;
s=[s_{τ}]=[(s_{τ1}, . . . , s_{τm})], i.e., the resource allocation matrix;
z=[z_{τ}] defined as the compression scaling factor vector.

Note that the data quality is maximum when z_{τ}=1 and decreases for lower values of z_{τ}. Consequently, the expected inference accuracy a_{τ} (z) is directly derived from z_{τ}, as it has no dependency from the resource allocation, while the expected latency l_{τ} (z, s) is a result of the choice of both z_{τ} and {s_{τk}} ∀k. The problem formalization according to the system constraints and definitions is given by:

$$\begin{matrix}Semantic Flexible Edge Slicing Problem ( SF - ESP ) & \\ \text{?} {\sum }_{T ϵ𝕋} ( \text{?} - {{\sum }_{k}}^{m} {ρ}_{k} \text{?} ) \text{?} & ( 1 a )\end{matrix}$$

$$s . t . {\sum }_{T ϵ𝕋} \text{?} \leq {S}_{k} , k = 1 , … , m , \qquad ( 1 b )$$

$$\text{?} ∈ ( 0 , 1 ] , ∀ τ ∈ 𝕋 , \qquad ( 1 c )$$

$$\text{?} ( \text{?} ) \geq \text{?} {x}_{T} , ∀ τ ∈ 𝕋 , c ∈ ℂ , \qquad ( 1 d )$$

$$\text{?} ( \text{?} , \text{?} ) \text{?} \leq {L}_{c} , ∀ τ ∈ 𝕋 , c ∈ ℂ , \qquad ( 1 e )$$

$$\text{?} ϵ \{ 0 , 1 \} , ∀ τ ∈ 𝕋 . \qquad ( 1 f )$$

$$\text{?} \text{indicates text missing or illegible when filed}$$

The objective function (1a) maximizes the revenue associated with allocated tasks x_{τ} by considering the task offer Oτ and the cost of task allocated resources pₖs_{τk}. Notice that the SF-ESP includes both integer and continuous variables, thus it belongs to the class of mixed integer nonlinear problems (MINLP). It can be shown that the problem is NP-hard.

The described embodiments have been evaluated through an extensive numerical analysis. Regarding the DL services, object detection and instance segmentation were considered, which are state-of-the-art problems in computer vision (CV). For the former, considered were (i) the widely-known Common Objects in Context (COCO) as the dataset, which is a large-scale image database containing more than 200K labeled examples across 80 object classes, and (ii) the YOLOX classifier, which is based on the Modified CSP v5 as the backbone and has 54.2M parameters. For the latter, selected were (a) the Cityscapes dataset, which contains pixel-level annotated video sequences of street scenes recorded in 50 different cities, and (b) the BiSeNet v2 real-time classifier, which is based on a bilateral segmentation backbone network and has 14.8M parameters. For performance evaluation purposes, a set of 10 object detection tasks were designed (see Table 2).

TABLE 2
Multi-object detection applications.

| Application | Target Classes |
|---|---|
| COCO All | Entire set of classes (80) of COCO |
| COCO Urban | Bicycle, car, motorcycle, bus, truck, traffic |
| | light, stop sign, person |
| COCO Bags | Handbag, backpack, suitcase |
| COCO Animals | Bird, cat, dog, horse, sheep, cow, |
| | elephant, bear, zebra, giraffe |
| COCO Person | Person |
| Cityscapes All | All evaluation classes (19) of Cityscapes |
| Cityscapes | Car, truck, bus, train, motorcycle, bicycle |
| Vehicles | |
| Cityscapes | Pole, traffic light, traffic sign |
| Objects | |
| Cityscapes Flat | Road, sidewalk |
| Cityscapes Person | Person |

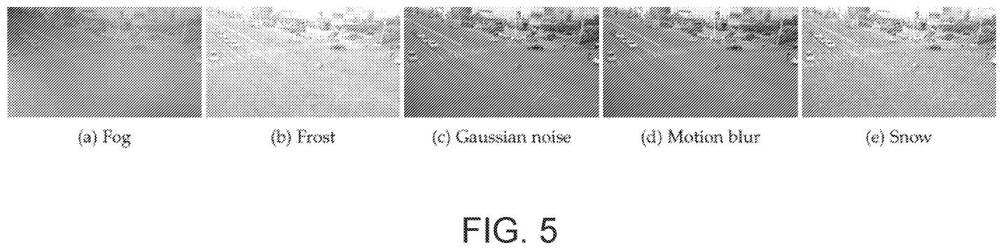

Intentional data degradation was considered, specifically image compression applied to save network bandwidth, and unintentional prior data degradation, such as the one caused by poor weather or illumination conditions. To apply compression, the Pillow python imaging library was used, which allows for the compression of an image by decreasing its resolution and saving it in JPEG format. To emulate the image quality degradation, the imagecorruptions python package was used, which provides a set of corruption effects at five different severity levels that can be applied to test the robustness of CV application to unseen perturbations. Of the several corruption effects available those in Table 3 were selected, for which an example is provided in FIG. 5. This example shows corruption effects of fog 502, frost 504, Gaussian noise 506, motion blur 508, and snow 510, each applied to the same underlying image using the minimum severity (0).

For comparison purposes, the following baselines were considered: (1) S1-EDGE, which is the state-of-the-art algorithm for RAN edge slicing; (2) MinRes-SEM, which is an algorithm that considers the semantics but, instead of flexibly allocating resources as do the described embodiments, it allocates the minimum resources for each task; (3) FlexRes-N-SEM, which implements flexible resource allocation but does not consider the semantics as do the described embodiments; (4) High-Comp, which compresses each task to 10% of its original size, so as to reach mAP of about 0.25 in the COCO dataset—this is a baseline that tries to compress aggressively tasks to minimize resources; (5) HighRes, which statically allocates tasks 20% of the total amount of resources—this is a baseline that attempts to maximize the probability that admitted tasks will meet application constraints.

The first-listed baseline, S1-EDGE, is a MEC slicing framework that allows network operators to instantiate heterogeneous edge slices. The key limitation of S1-EDGE is that it does not consider DL semantics and flexible resource allocation, which are the core advantages of the described embodiments. Indeed, we show that the example semantics-based RAN system allows for the allocation of up to 169% more tasks than S1-EDGE and 52% higher profits.

To investigate the impact of the above-described approach, considered were (i) different numbers (2 and 4) of edge/network resources (e.g., CPUs, GPUs, PRBs, etc.); (ii) different thresholds of accuracy (“low,” “medium,” and “high”) and latency (“low,” “high”). The accuracy thresholds A_{c} were defined as 0.20, 0.35, and 0.55 mAP for object detection tasks and 0.35, 0.50, and 0.70 mean Intersection over Union (mIoU) for instance segmentation tasks, while for latency threshold L_{c} we choose 0.2 seconds and 0.7 seconds. Tasks are equally distributed across the applications defined in Table 2. A latency function l_{τ} was empirically formulated that expresses the computational and network latency as a function of compression factor, resource allocation, and task generation rate. All numerical results were derived by repeating the experiments 64 times to obtain statistically meaningful results. Unless otherwise specified, all tasks have the same offer

$${O}_{τ} = {\sum }_{k}^{m} {S}_{k}$$

and all resources have the same price pₖ=1/Sₖ.

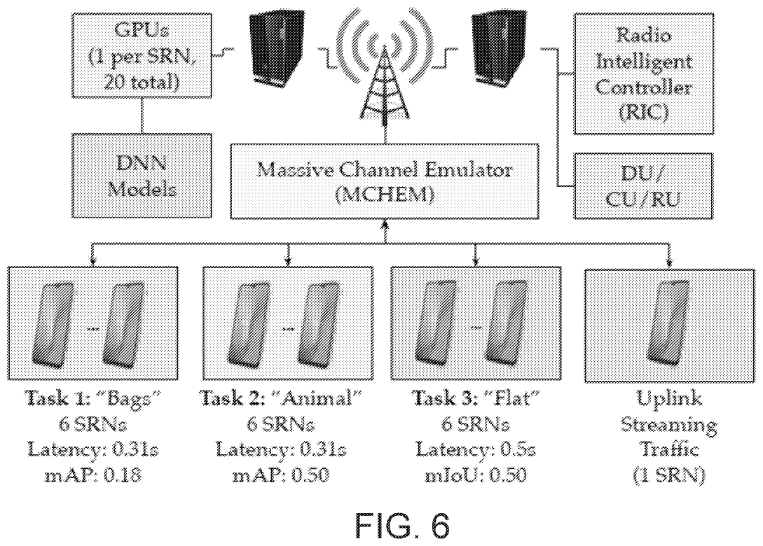

A proof of concept of a semantics-based RAN system according to the invention was designed and developed on the Colosseum network emulator, and used the open-source SCOPE framework as prototyping platform for 5G-and-beyond cellular networks (NextG) systems. Since SCOPE did not support the uplink slicing of resources, SCOPE was extended to implement uplink slicing as well. FIG. 6 shows a high-level overview of the semantics-based RAN system example embodiment. A set of 20 Standard Radio Nodes (SRNs) was utilized to implement the OPEN RAN network, with 1 SRN used to process received jobs of admitted tasks and to implement the DU/CU/RU and the RIC, where the slice admission system and the solvers of the SF-ESP was run, implemented in MATLAB. Out of the remaining 19 SRNs, to emulate traffic separated from the mobile applications requiring RAN slices, one SRN was used to generate uplink streaming traffic with the iperf tool. The other 18 SRNs were used to implement a system where a VNO requests three slices for object detection tasks. Up to 20 Tesla K40m GPUs can be utilized to run the DNNs. As for the PHY, the standard SCOPE parameters were utilized, i.e., 10 MHz of bandwidth corresponding to 50 PRBs in total grouped in 17 RBGs. Uplink streaming traffic was assigned 2 RBGs, thus, 15 RBGs were available for slicing. To run the DL models on inference data, the Nvidia GPU of each SRN was made available through the collaboration network using a round-robin load balancer based on Nginx, so that a task could effectively run on multiple GPUs by distributing inference frames according to the slicing decision

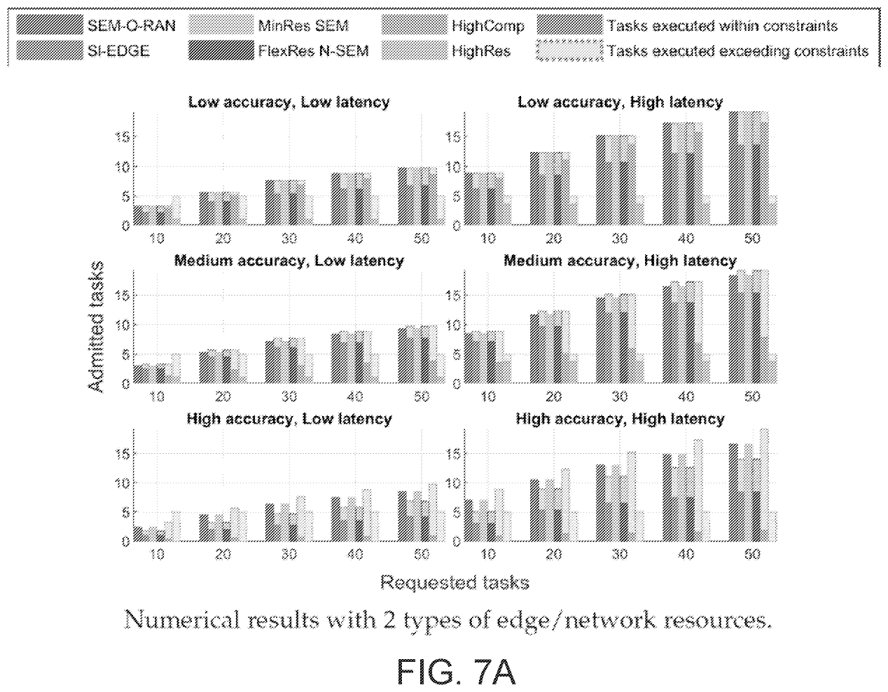

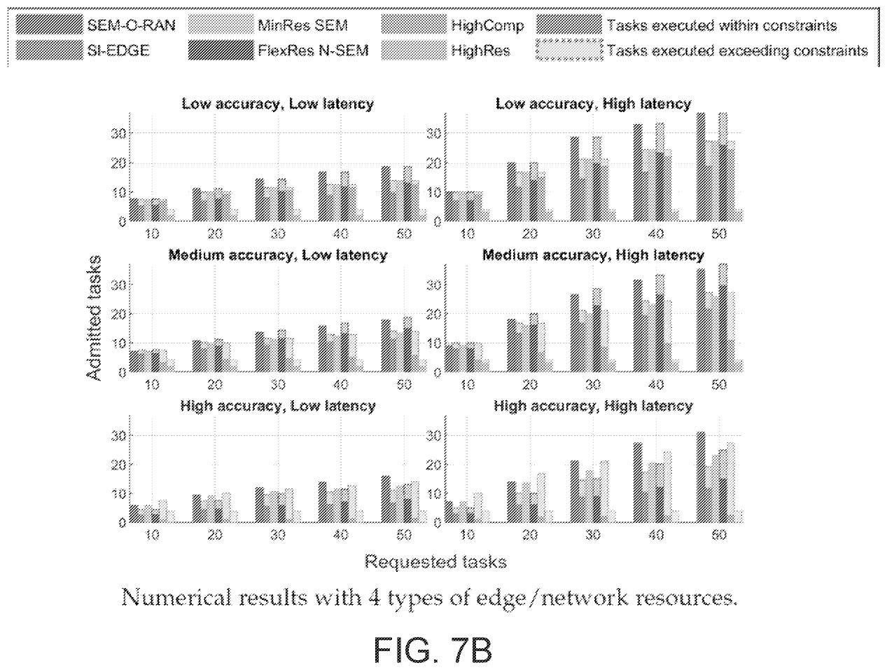

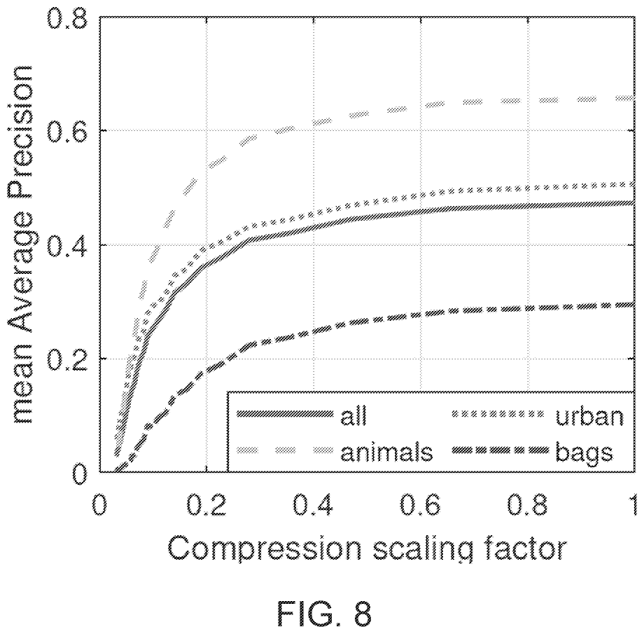

FIGS. 7A and 7B show the number of allocated tasks by the example embodiment of a semantics-based RAN system and the baseline algorithms, as a function of the number of requested tasks when 2 and 4 types of edge/network resources are available. FIG. 7A shows that, in general, the performance of the example semantics-based RAN system is similar to that given by MinRes-SEM. Even when the requirements are medium accuracy and high latency, the example semantics-based RAN system allocates 20% more tasks than S1-EDGE and FleRes-N-SEM, and 402% more tasks than HighRes, when 50 tasks are generated. On the other hand, when the accuracy requirements deviate from medium, the example semantics-based RAN system delivers significantly better performance than S1-EDGE. Specifically, when high mAP/mIoU is required, only the example semantics-based RAN system and MinRes-SEM are able to allocate tasks that meet the requirements. S1-EDGE does not allocate tasks since S1-EDGE considers all the tasks as belonging to the “All” application, which can never reach the required mAP/mIoU of 0.55/0.70 (see FIG. 8, which shows Mean Average Precision (mAP) as a function of the compression scaling factor for the application classes defined in Table 2). While HighComp and HighRes do allocate tasks, they will not meet the requirements. The reason is that HighComp and HighRes allocate tasks while being agnostic of the target latency and accuracy. The effect of joint semantic slicing and flexible resource allocation is even more evident in FIG. 7B, where more types of edge/network resources are considered. In this case, the example semantics-based RAN system overperforms all the other schemes in all the considered scenarios, especially when the number of tasks increases and the requirements become more stringent. The results indicate that the example semantics-based RAN system allocates up to 169% more tasks than the existing state-of-the-art S1-EDGE algorithm and 18.5% on average.

To make the example semantics-based RAN system robust to perturbation in the image quality, the example semantics-based RAN system's DQDM artificially corrupts datasets' images to learn the tolerable compression according to the application class. The importance of anticipating perturbations in the image quality is evaluated by testing the example semantics-based RAN system performance when tasks input data is degraded by artificial image corruption effects. Table 4 shows the comparison between the example semantics-based RAN system and S1-Edge, with and without the presence of the DQDM, which adds robustness to perturbations in the image quality in the presence of image degradation at different severity levels.

TABLE 4
Data quality impact on admitted and successful tasks
according to varying degradation severity levels.

| | Tasks | | | | | | | |
|---|---|---|---|---|---|---|---|---|
| | Admitted | | | | Successful | | | |
| | Severity | | | | | | | |
| Solution | 0% | 20% | 60% | 100% | 0% | 20% | 60% | 100% |
| SEM-O-RAN | 19.43 | 16.02 | 11.54 | 8.60 | 19.43 | 16.02 | 11.53 | 8.60 |
| SEM-O-RAN w/o DQDM | 19.43 | 19.45 | 19.47 | 19.44 | 19.43 | 4.18 | 0.71 | 0.27 |
| Sl-Edge w/DQDM | 15.64 | 12.63 | 8.52 | 5.69 | 11.17 | 9.21 | 6.11 | 3.95 |
| Sl-Edge w/o DQDM | 15.64 | 15.74 | 15.70 | 15.66 | 11.17 | 8.36 | 4.72 | 2.92 |

The reported values are calculated by considering 50 requested tasks that are affected by data degradation caused by an effect randomly selected from those in Table 3. Then, the results are averaged over the values collected from the experiments conducted using the parameters described herein with respect to impact of the approach. The example semantics-based RAN system is always able to successfully execute all the allocated tasks, whose number decreases with the increase of the severity. Of the 19.43 average tasks successfully executed when no degradation is applied, only 8.60 are accepted and successfully executed when the degradation is maximum. If the DQDM is deactivated, the example embodiment of a semantics-based RAN system is no longer able to guarantee the successful execution of all the admitted tasks. Furthermore, the selected compression is often too aggressive, which causes a minimum of 0.27 successful tasks when the maximum degradation is applied. S1-Edge, when integrated with the DQDM, is able to accept a fair number of tasks but, as seen in the task allocation results, since it does not consider the individual object classes, delivers worse results than the example semantics-based RAN system, as only 3.95 tasks are successfully executed at 100% severity. However, for the same reason, when the DQDM is disabled, S1-Edge is always able to successfully execute more tasks than the example semantics-based RAN system for all non-zero severity levels. To conclude, as the example semantics-based RAN system's capability of successfully meeting tasks' accuracy requirements is strongly affected by the fidelity of the accuracy function when working with real data, the DQDM is fundamental in a real-world scenario when tasks' input data may be affected by disturbances.

### Comparison of the Example Semantics-Based RAN System and Baselines

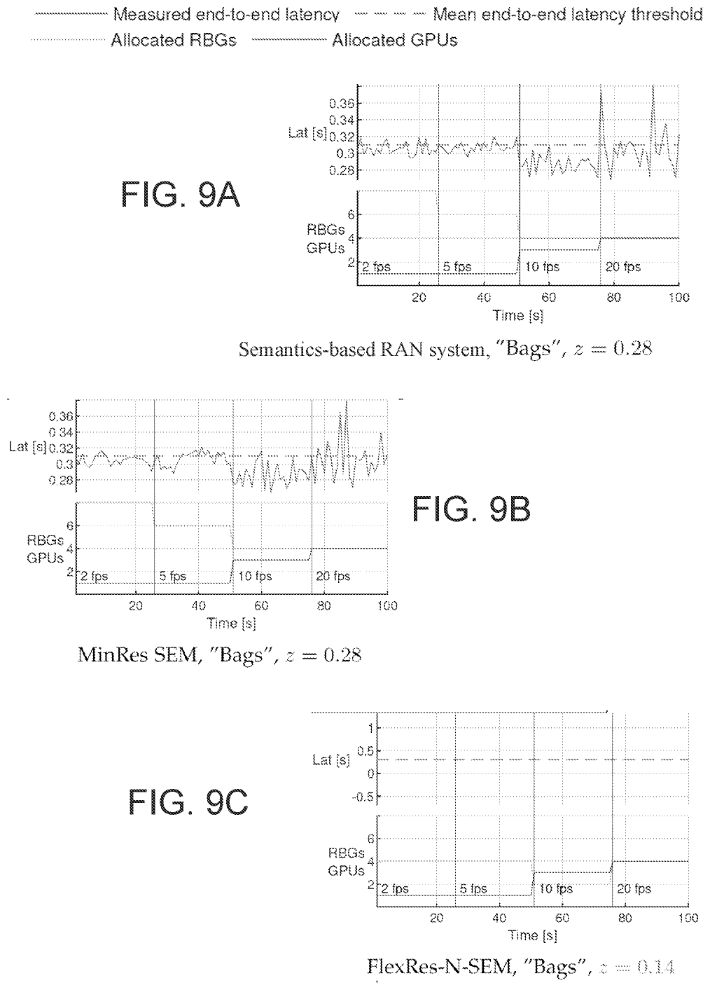

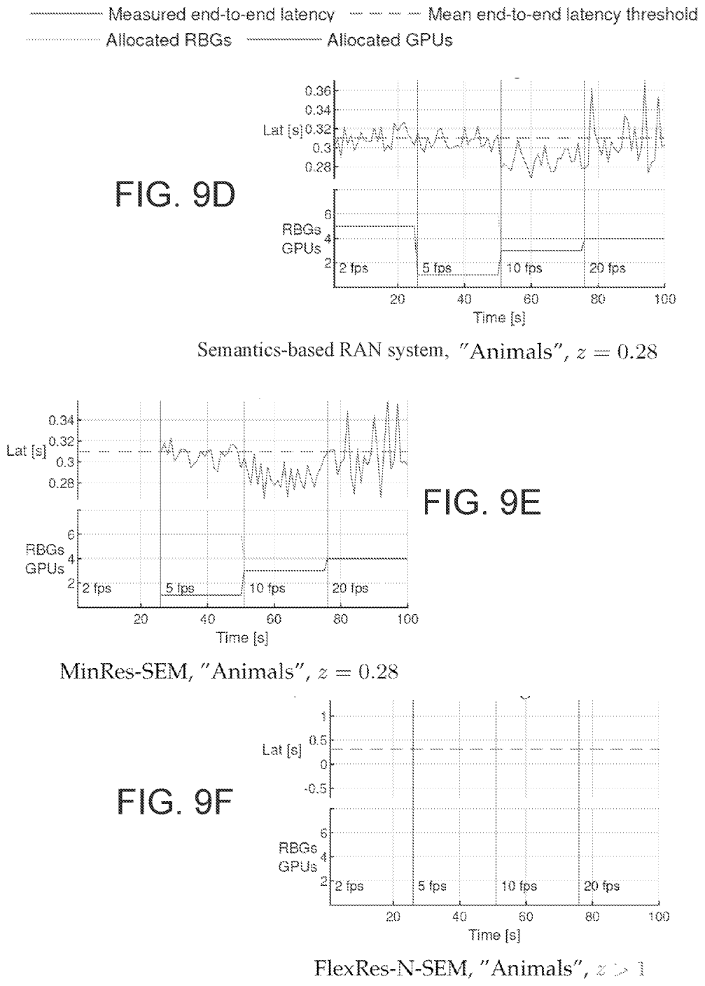

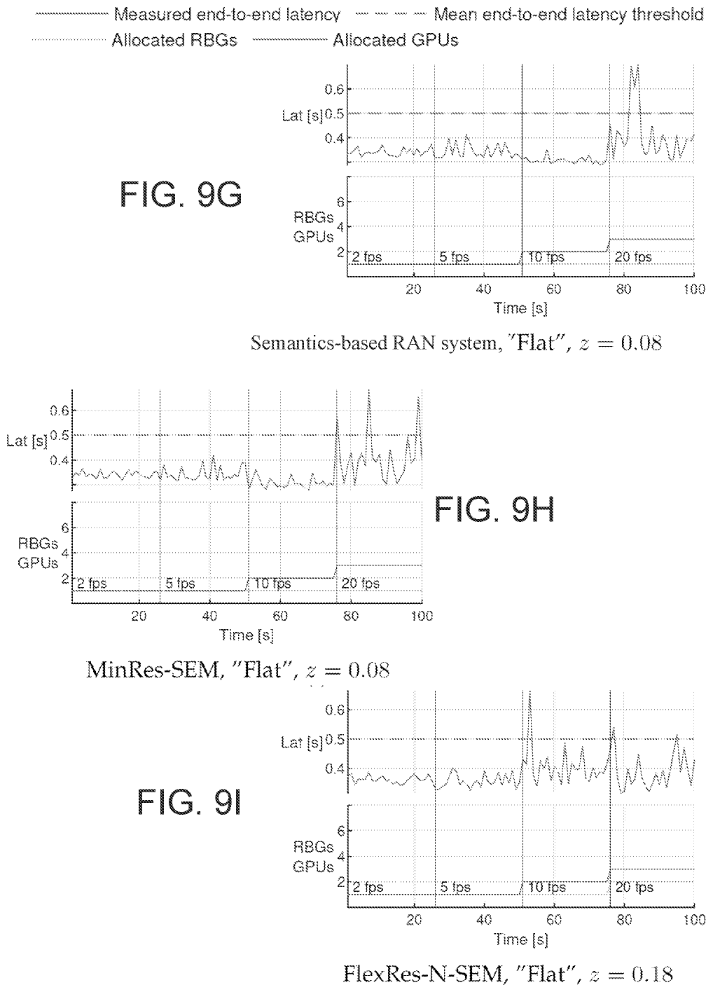

FIGS. 9A-9I show experimental results on Colosseum, in which the VNO slice requirements are changed by updating the number of frames per second (fps) that will be generated by each UE every 25 seconds, while latency and accuracy constraints are kept constant (values as shown in FIG. 6). Whenever the requirements are updated, SESM computes a new solution and enforces new slice configurations. Thus, the experimental end-to-end latency for each slice are reported as a function of time, as well as the end-to-end latency threshold requirement for each task. Comparing the example semantics-based RAN system to MinRes-SEM and FlexRes-NSEM demonstrates the advantage of flexible allocation and semantic slicing. Accordingly, the related output of the slicing algorithm in terms of RBGs (radio resources) and GPUs (computing resources) is presented. The example semantics-based RAN system successfully allocates “Bags”, “Animals” and “Flat”. Notice that the reason why RBG allocation decreases as the fps request decreases is that for lower values of fps, the experienced latency increases, since some time is spent for LTE uplink scheduling requests from the UEs. With higher fps, the UE is able to use RBGs granted by the eNB to exchange traffic pertaining to multiple frames, thus leading to lower latency even if network utilization is higher. In the third and fourth periods, all three tasks are allocated by the example semantics-based RAN system. The impact of flexible resources is demonstrated in FIG. 9E, where we see that MinRes-SEM does not allocate “Animals” in the first period. The reason is that the example semantics-based RAN system balences RBGs with GPUs, requesting 6 RBGs and 5 GPUs during the first period. Since MinRes-SEM would have requested 8 RBGs and 1 GPUs, this would have led to 16 RBGs in total, which exceeds system capacity. Finally, from FIGS. 9C, 9F, and 9I, it emerges that FlexRes-N-SEM, by not considering the semantics, performs worse than the former two approaches. By keeping in mind that FlexRes-N-SEM assumes that every task is of type “All,” it will compress the tasks in “Bags” to 14% of their original size to maximize the number of tasks allocated. Conversely, the example semantics-based RAN system and MinRes-SEM compress “Bags” to 28%, which leads to successful allocation since the mAP constraint will be met. Worse yet, FlexRes-N-SEM will allocate resources for “Bags” but the tasks will fail because they will not meet the required mAP. Thus, even if FlexRes-N-SEM saves resources by compressing more, it cannot achieve the required mAP. As shown in FIG. 9F, the “Animals” task is never admitted by FlexRes-N-SEM, because it assumes that a mAP of 0.5 can never be reached by “All,” while the example semantics-based RAN system and MinRes-SEM, by considering the semantics, compress the tasks to the optimal level and can successfully admit it. As for “Flat,” FlexRes-N-SEM is always able to allocate it successfully but, by assuming the type as the more complex “All,” it does not select the same aggressive compression factor that instead is chosen by the example semantics-based RAN system and MinRes-SEM (18% instead of 8%), at the cost of higher RBGs consumption in the latest period of FIG. 9I.

### Radio Channel Quality Impact on the Example Semantics-Based RAN System

In a real-world scenario, mobile devices experience different channel conditions which may impact the performance of the radio communication. To show how the example semantics-based RAN system behaves in this situation, Colosseum is used to emulate a radio scenario where the devices' radio channels have varying SNRs, then the example semantics-based RAN system is provided with task latency functions formulated according to the radio channel status of the requesting device. Limiting the total available resources to 10 GPUs and 12 RBGs, we consider four object detection tasks T whose characteristics are summarized in Table 5, where also the available actions are listed.

TABLE 5
Task configurations for the example semantics-
based RAN system evaluation with devices experiencing
variable radio channel quality

| T | O | A | L | FPS | Object class | Allowed actions |
|---|---|---|---|---|---|---|
| 1 | 20 | 0.2 | 0.6 | 20 | Urban | z: [1, 0.28, 0.08] |
| 2 | 20 | 0.5 | 0.4 | 10 | Urban | RBG: [1 . . . 6, 8, 10] |
| 3 | 5 | 0.6 | 0.4 | 3 | Person | GPU: [1 . . . 5] |
| 4 | 5 | 0.6 | 0.4 | 3 | Person | |

Tasks' configurations are chosen to achieve a good balance between required accuracy and fps. Moreover, T1 and T2, which are set with the highest offer, observe an SNR that varies each 100 s period. FIGS. 9A-9I show the obtained results, where tasks' latencies and assigned resources are reported when the tasks are admitted and consequently executed. Initially, all tasks are admitted except for Task 2, even if it offers the highest value, because no resource allocation between those allowed can satisfy the latency requirement when the SNR is as low as 15 dB. During the second period, the SNR measured by the device requesting Task 2 rises to 20 dB, which allows for the admission of the task with a large resource allocation. Because of this, Task 4 can no longer be admitted and therefore it is stopped. During the third period, the SNR relative to Task 2 rises to 25 dB, which allows the example semantics-based RAN system to respect the latency requirement with a smaller resource allocation. The freed resources can now be used by the resumed Task 4. The fourth period is similar to the second one, except now T1 is executed with a lower SNR, which however does not require more resources to be allocated. This does not hold in the last period, where more resources are needed to execute T1. Coincidentally, the larger allocation required by T1 is balanced by the smaller one required by T2, thus there is no need to stop T3 to free resources for higher offering tasks. The only difference between T3 and T4 is the higher SNR of the former, which allows for a lower resource allocation ((3,1) vs (4,2)) and thus, as observed, a lower probability of being stopped to yield to higher offering tasks.

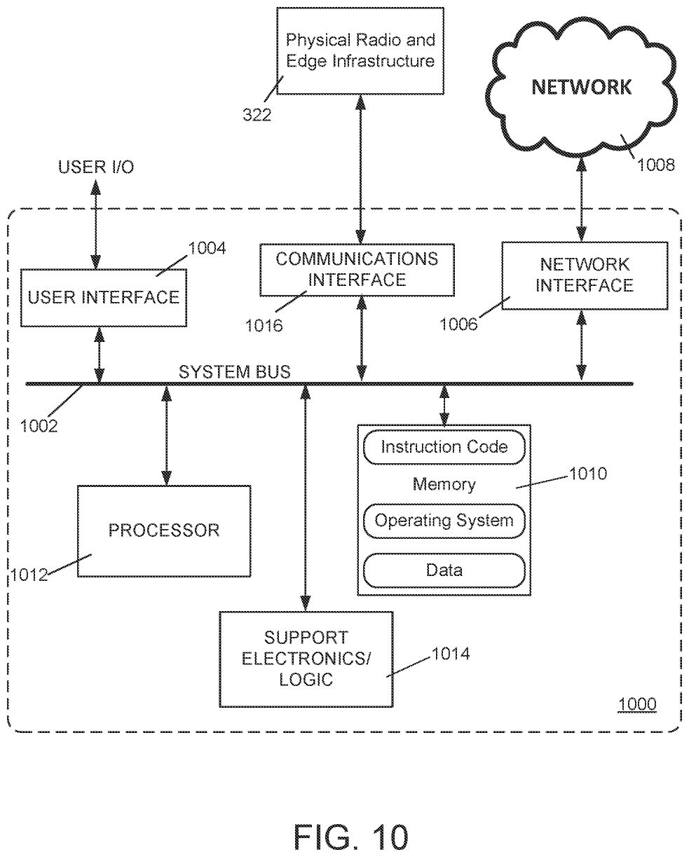

FIG. 10 is a diagram of an example internal structure of a processing system 1000 that may be used to implement one or more of the embodiments herein. Each processing system 1000 contains a system bus 1002, where a bus is a set of hardware lines used for data transfer among the components of a computer or processing system. The system bus 1002 is essentially a shared conduit that connects different components of a processing system (e.g., processor, disk storage, memory, input/output ports, network ports, etc.) that enables the transfer of information between the components.

Attached to the system bus 1002 is a user I/O device interface 1004 for connecting various input and output devices (e.g., keyboard, mouse, displays, printers, speakers, etc.) to the processing system 1000. A network interface 1006 allows the computer to connect to various other devices attached to a network 1008. Memory 1010 provides volatile and non-volatile storage for information such as computer software instructions used to implement one or more of the embodiments of the present invention described herein, for data generated internally and for data received from sources e10ternal to the processing system 1000.

A central processor unit 1012 is also attached to the system bus 1002 and provides for the e10ecution of computer instructions stored in memory 1010. The system may also include support electronics/logic 1014, and a communications interface 1016. The communications interface 1016 may communicate with the physical radio and edge infrastructure 322 described with reference to FIG. 3A.

In one embodiment, the information stored in memory 1010 may comprise a computer program product, such that the memory 1010 may comprise a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

While example embodiments have been particularly shown and described, it will be understood by those skilled in the art that various changes in form and details may be made therein without departing from the scope of the embodiments encompassed by the appended claims.

What is claimed is:

1. A method of facilitating communication between (a) one or more communication devices and (b) a wireless radio access network, comprising:
determining a semantic aspect of one or more prioritized classes of an application;
compressing data according to the semantic aspect to produce compressed data; and
wirelessly communicating the compressed data to the wireless access network.

2. The method of claim 1, wherein determining the semantic aspect of the one or more prioritized classes further comprises (i) receiving inference accuracy requirements of an associated task, and (ii) determining an inference accuracy of the one or more prioritized classes with respect to a level of compression of collected data that is communicated to the wireless access network.

3. The method of claim 1, further comprising optimizing a network slice configuration according to the semantic aspect.

4. The method of claim 3, wherein optimizing a network slice configuration further comprises (i) determining an accuracy function, (ii) using the accuracy function to generate an accuracy value, (iii) determining a latency function, (iv) using the latency function to generate a latency value, and (v) using the accuracy value and the latency value to solve a Semantic Flexible Edge Slicing Problem (SF-ESP).

5. The method of claim 1, wherein the wireless access network is an open radio access network (Open RAN)

6. The method of claim 3, further comprising collecting data that is associated with the one or more prioritized classes, compressing the data according to the semantic aspect to produce compressed data, and wirelessly communicating the compressed data to the wireless access network.

7. The method of claim 1, further comprising conveying the one or more prioritized classes through one or both of a task descriptor and a set of task requirements.

8. A method of facilitating communication between (a) one or more communication devices and (b) a radio access network, comprising:
determining a semantic aspect of one or more prioritized classes of an application;
optimizing a configuration according to the semantic aspect, the configuration being one or both of a network configuration and a computing configuration.

9. The method of claim 8, wherein optimizing the configuration further comprises (i) determining an accuracy function, (ii) using the accuracy function to generate an accuracy value, (iii) determining a latency function, (iv) using the latency function to generate a latency value, and (v) using the accuracy value and the latency value to solve a Semantic Flexible Edge Slicing Problem (SF-ESP).

10. The method of claim 9, further comprising using an output of the SF-ESP to (a) select which tasks to admit, (b) determine a compression level associated with the tasks to be admitted, and (c) determine one or more computational resources and a number of Physical Resource Blocks to be assigned to each admitted task.

11. The method of claim 8, wherein determining the semantic aspect of the one or more prioritized classes further comprises (i) receiving inference accuracy requirements of an associated task, and (ii) determining an inference accuracy of the one or more prioritized classes with respect to a level of compression of collected data that is communicated to the radio access network.

12. The method of claim 8, further comprising collecting data that is associated with the one or more prioritized classes, compressing the data according to the semantic aspect to produce compressed data, and wirelessly communicating the compressed data to the wireless access network.

13. The method of claim 8, wherein the wireless access network is an open radio access network (Open RAN).

14. A method of optimizing one or both of a network configuration and a computing configuration, comprising:
sending one or more task descriptors to a semantic deep learning analyzer (SDLA);
sending (i) a latency function, (ii) an accuracy function, (iii) one or more task requirements, (iv) a current radio channel status, (v) data quality, and (vi) edge resources to a semantic edge slicing module (SESM), and producing, by the SESM, radio access network (RAN) and edge slicing parameters therefrom;
sharing current radio/edge status information with the SDLA for refinement of latency functions.

15. The method of claim 14, wherein the SDLA resides in a non-real-time RAN intelligent controller (RIC), and the SESM resides in a near-real-time RIC.

16. The method of claim 14, wherein the RAN and edge slicing parameters include resource block specification, per-task compression level, and computation resource specification.

17. A system for facilitating communication between (a) one or more communication devices and (b) an open radio access network (Open RAN), comprising:
a virtual network operator (VNO) space for producing an Open RAN configuration request;
a semantic deep learning analyzer (SDLA) that receives the Open RAN configuration request and produces latency and accuracy functions therefrom;
a semantic edge slicing module (SESM) that receives the latency and accuracy functions, one or more task requirements, radio information, and computation information, and produces Open RAN configuration information, computation configuration information, and per-task compression level information.

18. The system of claim 17, wherein the Open RAN configuration request comprises a task descriptor that describes deep learning (DL) service, a DL model, and at least one DL target class, and at least one task requirement that describes required latency, required accuracy, number of user equipment (UEs) devices, and tasks per second to be processed.

19. The system of claim 17, wherein the SESM produces RAN and edge configuration parameters comprising a resource block specification, a per-task compression level, and a computation resource specification.

20. The system of claim 19, wherein the SESM provides the RAN and edge configuration parameters to a physical radio and edge infrastructure.
